(19) United States
(12) Patent Application Publication
(10) Pub. No.: US 2011/0049941 A1
(43) Pub. Date: Mar. 3, 2011

(54) FOLDING TOP ARRANGEMENT FOR A CONVERTIBLE

(75) Inventor: Heinrich WÜLLRICH, Furstenstein (DE)

(73) Assignee: Webasto-Edscha Cabrio GmbH, Stockdorf (DE)

(21) Appl. No.: 12/874,742

(22) Filed: Sep. 2, 2010

(30) Foreign Application Priority Data
Sep. 3, 2009 (DE) 10 2009 039 926.7

(51) Int. Cl. B60J 7/047

(52) U.S. Cl. 296/220.01

(57) ABSTRACT

A folding top arrangement for a convertible, comprising a first roof part, and a holding part, wherein the first roof part is arranged in front of the holding part when the folding top is closed, wherein the first roof part can be pivoted rearward over the holding part, wherein the first roof part is mounted on the holding part by means of a drivable first kinematic linkage, wherein the first kinematic linkage comprises a first, front, roof part link, a second, rear, roof part link, a first auxiliary link and a second auxiliary link, wherein the holding part, the first roof part link, the first auxiliary link and the second auxiliary link together form a first four-bar arrangement, wherein the holding part forms a ground link of the first four-bar arrangement, and wherein the first roof part link forms a coupler of the first four-bar arrangement.

### BACKGROUND

EP 1 398 195 A1 describes a folding top arrangement for a convertible with a first roof part, which is at the front in the direction of travel, a second roof part, which is at the rear in the direction of travel, and a third, central, roof part. The three roof parts are each designed as rigid shell components and completely cover the interior of the convertible when the folding top is closed. To enable the folding top to be opened, the three roof parts can be arranged as a roof part stack that can be deposited in a rear area of the convertible. For this purpose, is the folding top arrangement comprises a main link mechanism comprising a first main link and a second main link, both of which are pivotally attached to the vehicle body, and a holding part, which connects the first main link to the second main fink, with the result that the vehicle body, the holding part, the first main link and the second main link together form a main four-bar arrangement, the coupler of which is formed by the holding part. A main four-bar arrangement is provided in the region of each of the two vehicle side faces. When the folding top is closed, the third roof part extends over the interior of the vehicle in the transverse direction of the vehicle and, on each side of the vehicle, is connected immovably to the holding part provided there. Each of the holding parts has a first mounting section, which extends forward in relation to the direction of travel, beyond the third roof part, and a second mounting section, which extends rearward beyond the third roof part. When the folding top is closed, the first roof part is arranged in front of the third roof part and, to open the folding top, can be pivoted rearward into a position above the holding part. For this purpose, the first roof part is mounted on the first mounting section of the holding part, on the one hand, and on the third roof part, on the other hand, by means of a drivable first kinematic linkage. The first kinematic linkage comprises a first, front, roof part link and a second, rear, roof part link, the first roof part link being connected pivotably to the first roof part at a first pivot point and being connected pivotably to the first mounting section of the holding part at a second pivot point. At a first end, the second roof part link is connected pivotably to an edge of the first roof part which is at the rear in relation to the direction of travel. At its second end, the second roof part link is furthermore pivoted to the third roof part by means of a four-bar arrangement. For this purpose, the four-bar arrangement has a first link and a second link, which are pivoted to the second end of the second roof part link and to the third roof part respectively. The third roof part thus forms a ground link and the second roof to part link forms a coupler of the four-bar arrangement. When the folding top is closed, the second roof part link is accommodated completely in a depression provided in the third roof part. Starting from the closed position, the first roof part is pivoted rearward into a position above the holding part and the third roof part by pivoting the first roof part link and the second roof part link. To drive this pivoting motion, a kinematic drive mechanism comprising a first auxiliary link, a second auxiliary link and a coupler rod is provided. A first end of the first auxiliary link is pivotally attached to the first roof part link at a third pivot point arranged between the first pivot point and the second pivot point and, at its second end, the first auxiliary link is connected to a first end of the second auxiliary link at a fourth pivot point. The second auxiliary link is pivotally attached to the holding part at a fifth pivot point, with the result that the holding part, the first auxiliary link, the first roof link and the second auxiliary link together form a first four-bar arrangement, in which the holding part forms a ground link of the first four-bar arrangement and the first auxiliary link forms a coupler of the first four-bar arrangement. The coupler rod engages on the first four-bar arrangement in the region of the fourth pivot point, with the result that pivoting of the first four-bar arrangement and hence pivoting of the first roof part link relative to the holding part can be driven and controlled by means of the coupler rod. One disadvantage with this folding top arrangement is that the second roof part link, which can be lowered into the third roof part, necessitates a complex seal for the depression provided in the third roof part and furthermore necessitates an expensive optical cover for the second roof part link when the folding top is closed. Another disadvantage is that the first mounting section of the holding part extends a relatively long way forward in the direction of travel beyond the extent of the third roof part, with the result that the holding part has a relatively large extent in comparison with the third roof part and, when the folding top is completely opened, takes up a correspondingly large amount of deposition space in the rear area of the convertible. The large amount by which the first mounting section projects forward beyond the third roof part is necessary especially because the first roof part link rests against a front edge of the third roof part when the first roof part has been pivoted rearward. The ratio of the length of the first mounting section to the height of the third roof part therefore determines the angle at which the first roof part link is arranged relative to the horizontal in the deposition position of the first roof part and hence also the vertical distance between the first roof part, which is mounted on the first roof part link, and the third roof part. In order to achieve compact deposition of the first roof part above the third roof part in terms of vertical extent, it is therefore necessary that the first mounting section should extend a correspondingly long way forward beyond the third roof part.

DE 10 2007 054 469 A1 describes a folding top arrangement for a convertible, which is designed as a folding cloth top. The folding top arrangement comprises a link mechanism arranged on each side of the vehicle, a front bow and a number of bows which span the interior of the vehicle in the transverse direction when the folding top is closed. The link mechanism comprises a first main link and a second main link, each of which has a first end pivotally attached to the vehicle body and a second end remote from the vehicle body. The link mechanism furthermore comprises a holding part, which is pivoted to the first main link in the region of the second end and which extends forward in the direction of travel, starting from the first main link, when the folding top is closed. The holding part is pivoted to the second end of the second main link by way of a short coupler link. A first roof part including the front bow is mounted pivotably at a first pivot point at an end of the holding part remote from the first main link. As the folding top is opened, the first roof part can be pivoted upward and rearward about the first pivot point, with the result that an inner side of the front bow, which faces the interior of the vehicle when the folding top is closed, faces vertically upward when the folding top is completely opened. At a first end remote from the first main link and the second main link, a coupler rod extending substantially parallel to the holding part is pivoted to a first end of a first auxiliary link, which is connected pivotably to the first roof part at a second end. A pivoting motion of the first roof part can thus be controlled by a mutually parallel relative motion of the coupler rod and the holding part.

DE 102 43 070 A1 describes a folding top arrangement for a convertible in which a first roof part, which is at the rear in relation to the direction of travel, is pivotally attached to the vehicle body by means of a first, rear, roof part link and a second, front, roof part link. The first roof part can be pivoted forward in relation to the direction of travel. For this purpose, the vehicle body, the first roof part, the first roof part link and the second roof part link together form a four-bar arrangement. The second roof part link is designed as a knee lever and has a long first link arm, which attaches the first roof part pivotally to the vehicle body, and a short second link arm, which is arranged at an angle to the first link arm. The second link arm forms a first auxiliary link of a further four-bar arrangement. The further four-bar arrangement comprises a second auxiliary link, which is arranged so as to intersect with the first auxiliary link and is pivotally attached to the vehicle body at a first end, and a coupler link, which is connected pivotably to a second end of the first auxiliary link and of the second auxiliary link respectively.

DE 101 33 957 A1 describes a three-part rigid-shell folding top for a convertible. The folding top comprises a first roof part, which is at the front in the direction of travel, a second, central, roof part and a third roof part, which is at the rear in the direction of travel. The central roof part is mounted pivotably on the vehicle body by means of a main link mechanism designed as a four-bar. The central roof part has an extension which points forward in the direction of travel, and the central roof part and the extension together form a holding part for a kinematic linkage which holds the first roof part. The kinematic linkage comprises a first link and a second link, the holding part, the first link, the second link and the first roof part together forming a four-bar arrangement, the ground link of which is the holding part and the coupler of which is the first roof part.

DE 101 50 218 A1 describes a rigid-shell folding top for a convertible comprising a first, front, roof part, a second, central, roof part and a third, rear, roof part. The second roof part is pivotally attached to the vehicle body by means of a main link mechanism designed as a four-bar. The first roof part is pivotally attached to a holding part comprising the central roof part by means of a first kinematic linkage, which comprises a first, front, roof part link, and a second, rear, roof part link. The first roof part link is connected pivotably to the first roof part at a first pivot point and is connected pivotably to an extension of the central roof part, said extension pointing forward in the direction of travel, at a second pivot point. The first link mechanism furthermore comprises an auxiliary link and a coupler link. The auxiliary link is designed as a toggle and is connected pivotably at a first end to the extension of the central roof part and is connected pivotably at a second end to a first end of the coupler link. A second end of the coupler link is connected pivotably to a section of the first roof part link which extends beyond the second pivot point. The extension of the central roof part, the first roof part link, the auxiliary link and the coupler link together form a four-bar arrangement, the ground link of which is the extension of the central roof part and the coupler of which is the coupler link. The four-bar arrangement is used to improve the introduction of torque into the first roof part link, for which purpose a drive rod engages on the auxiliary link.

DE 102 43 085 A1 describes a three-part rigid-shell folding top for a convertible, in which a first roof part, which is at the front in the direction of travel, is pivotally attached to a holding part comprising a second, central, roof part by means of a first kinematic linkage. The first kinematic linkage comprises a first, front, roof part link and a second, rear, roof part link, which are each connected pivotably at a first end to the holding part and pivotably at a second end to the first roof part. The kinematic linkage furthermore comprises a first auxiliary link and a second auxiliary link. The first auxiliary link is connected pivotably at a first end to the first roof part link and at a second end to a first end of the second auxiliary link. The second auxiliary link is connected pivotably to the holding part at a second end, with the result that the holding part, the first roof part link, the first auxiliary link and the second auxiliary link together form a four-bar arrangement, the ground link of which is formed by the holding part and the coupler of which is formed by the first auxiliary link.

### SUMMARY OF THE INVENTION

It is an object of the invention to specify a folding top arrangement for a convertible which allows roof parts to be deposited in a space-saving manner in the completely opened position of the folding top.

It is an further object of the invention to specify a folding top arrangement which allows roof parts to be deposited in securely fixed positions.

According to a first aspect of the invention, these objects are achieved by a folding top arrangement for a convertible, comprising a first roof part, and a holding part, wherein the first roof part is arranged in front of the holding part when the folding top is closed, wherein the first roof part can be pivoted rearward over the holding part, wherein the first roof part is mounted on the holding part by means of a drivable first kinematic linkage, wherein the first kinematic linkage comprises a first, front, roof part link, a second, rear, roof part link, a first auxiliary link and a second auxiliary link, wherein the holding part, the first roof part link, the first auxiliary link and the second auxiliary link together form a first four-bar arrangement, wherein the holding part forms a ground link of the first four-bar arrangement, and wherein the first roof part link forms a coupler of the first four-bar arrangement.

According to a further aspect of the invention, these objects are achieved by a support arrangement for fixing a roof part relative to a holding part of a folding top arrangement, comprising a gripping element that can be brought into engagement with the roof part, and a kinematic control mechanism that guides the gripping element, wherein the gripping element can be moved by means of the kinematic control mechanism between a position in engagement with the roof part and a position released from the roof part, and wherein a movement of the gripping element can be coupled to a movement of the roof part.

By virtue of the fact that the first roof part link forms a coupler of the first four-bar arrangement, the first roof part link can advantageously be moved over a relatively large spatial area relative to the holding part. In particular, that end of the first roof part link which is adjacent to the holding part can be moved vertically upward and rearward relative to the holding part, starting from the completely closed position of the folding top, by means of the first auxiliary link and of the second auxiliary link. This advantageously makes it possible to move the first roof part link into a virtually horizontal position substantially parallel to the holding part when the first roof part has been moved fully to the rear, even when an obstacle that has at least one vertically upward component of extension and limits the pivoting travel of the first roof part link is arranged on the holding part. A large distance in a horizontal direction between the obstacle and the pivotal attachment of the first roof part link to the holding part is rendered unnecessary by the upward and/or rearward movement of the pivotal attachment point of the first roof part link, with the result that, in comparison with a conventional folding top, in which the first roof part link is pivotally attached to the holding part directly at a pivot point and therefore cannot be moved away from the latter, the required forward extent of the holding part to accept the first roof part link is considerably reduced. The arrangement of the first roof part in front of the holding part and the possibility of pivoting the first roof part rearward over the holding part encompass both an arrangement of the first roof part in front of the holding part in relation to the direction of travel of the convertible, in which the pivotability of the first roof part toward the rear includes pivotability at least predominantly counter to the direction of travel, and an arrangement of the first roof part in front of the holding part in relation to a direction counter to the direction of travel of the convertible, in which the pivotability of the first roof part toward the rear includes pivotability at least predominantly in the direction of travel. In the case of a folding top with a plurality of roof parts, the first roof part can thus be designed as a roof part which is at the front, a roof part which is at the rear or a roof part which is arranged between other roof parts in relation to the direction of travel of the convertible. The first four-bar arrangement preferably comprises only the pivot points of the first auxiliary link and the second auxiliary link with respect to the first roof part and the holding part respectively. However, it has to be understood that further pivot points can be provided, the first four-bar arrangement thus forming, in particular, part of a seven-bar arrangement or of a multi-bar arrangement of some other configuration. It is expedient for the first kinematic linkage to be driven by engagement of a drive element on the first four-bar arrangement, and a leverage ratio of the drive element at the point of engagement on the four-bar arrangement is preferably chosen so that a pivoting motion of the first roof part can be driven with little expenditure of force, starting either from the completely closed position of the folding top or from the completely opened position of the folding top.

Preferably, it is possible to arrange the first auxiliary link and the second auxiliary link in a position in which they intersect. This advantageously makes it possible to impose a rotary motion on the first roof part link over a particularly large angular range in order to allow a large pivoting travel of the first roof part. It has to be understood that the first auxiliary link and the second auxiliary link can expediently be arranged parallel to one another with respect to their pivoting plane and/or can be designed so as to be offset in a direction perpendicular to their pivoting plane in order to facilitate or allow intersection.

The folding top arrangement expediently comprises a kinematic drive mechanism, which drives the first kinematic linkage. The kinematic drive mechanism preferably comprises a first drive link, a second drive link and a coupler rod, and, in a first preferred embodiment, the first drive link is coupled rigidly either to the first auxiliary link or to the second auxiliary link. A pivoting motion of the first roof part can thus be controlled directly by pivoting the first drive link. The rigid coupling of the first drive link with either the first auxiliary link or the second auxiliary link can be provided either by a rigid connection between a drive link and an auxiliary link that are provided fundamentally as separate components or by means of a one-piece design of the drive link and the auxiliary link, e.g. as a knee lever. It is particularly advantageous for the first drive link to be guided at least predominantly parallel to either the first auxiliary link or the second auxiliary link as the first roof part is pivoted. According to a second, likewise preferred, embodiment, the holding part, one of the first auxiliary link and the second auxiliary link, the first drive link and the second drive link together form a four-bar drive arrangement, in which the coupler rod is pivotally attached at a pivot point of the four-bar drive arrangement. It is expedient if the coupler rod engages on the first drive link, the second drive link or the common pivot point of the first drive link and the second drive link in a region situated at a distance from the holding part. This embodiment advantageously allows great mobility of the coupler rod relative to the elements of the first kinematic linkage and simultaneously allows a sufficiently large torque to be introduced into the first kinematic linkage.

The folding top preferably comprises a second roof part, the second roof part expediently being mounted on the holding part by means of a drivable kinematic linkage.

The second roof part is expediently arranged behind the holding part when the folding top is closed, and the second roof part can preferably be pivoted forward over the holding part. In a first preferred embodiment in this context, the first roof part and the second roof part together cover the interior of the convertible completely when the folding top is closed. According to another, likewise preferred, embodiment, at least one further roof part is provided in addition to the first roof part and the second roof part. The at least one roof part can be provided between the first and the second roof part when the folding top is closed. By virtue of the fact that the first roof part can be pivoted rearward over the holding part and the second roof part can be pivoted forward over the holding part, compact stacking of the roof parts, preferably in an alignment of a respective camber of the roof parts in the same direction, can be achieved when the folding top is completely opened. For this purpose, the second roof part can preferably be pivoted into a position above the first roof part. Particularly when space conditions in the deposition area for the roof parts render it expedient, the first roof part can be provided so as to be pivotable into a position above the second roof part. It is expedient if the second roof part comprises a rear window of the convertible.

The second kinematic linkage preferably comprises a third roof part link and a fourth roof part link, the holding part, the second roof part, the third roof part link and the fourth roof part link together forming a second four-bar arrangement. This advantageously enables the second roof part to be moved over a relatively large pivoting range by means of the second kinematic linkage and to be pivoted into a deposition position in which it completely covers the holding part and preferably also the first roof part. It has to be understood that pivotal attachment by means of a link pair corresponding to the first auxiliary link and the second auxiliary link can be provided in the case of at least one of either the third roof part link and the fourth roof part link. If a third roof part is provided, which is arranged between the first roof part and the roof part, an extent of a second mounting section of the holding part to accept the third roof part link and the fourth roof part link can thus be shortened in its rearward extent.

The second kinematic linkage is preferably positively coupled to the kinematic drive mechanism, and by this means a common activation of the first roof part and the second roof part in a definable time sequence is advantageously achieved. This embodiment furthermore advantageously makes it possible for the first and the second roof part to be driven in common by means of just one drive unit, which can be designed as a rotary motor or a linear drive unit, for example.

It is particularly preferred that the coupler rod is pivotally attached to one of the third roof part link and the fourth roof part link. This allows direct coupling of the first kinematic linkage and the second kinematic linkage, ensuring that a movement of the first roof part and the second roof part is driven and controlled directly in common.

The folding top arrangement preferably comprises a support arrangement for fixing the first roof part in the opened position of the folding top. The support arrangement, which particularly preferably engages on the first roof part in a rear area of the latter, advantageously allows immovable support for the first roof part in the deposited position, thus excluding or at least reducing unwanted vibration of the first roof part and the associated noise generation and increased wear produced during driving, especially by shocks on the convertible.

The support arrangement preferably comprises a catch hook that can be moved relative to the holding part. It is particularly preferred that the catch hook be mounted on the holding part by means of a first support link and a second support link, the holding part, the catch hook, the first support link and the second support link together forming a four-bar. The catch hook can thus be moved along a relatively large pivoting path and can be pivoted in an advantageous manner into an inoperative position in a region close to other parts of the second kinematic linkage, especially when the folding top is completely closed. The catch hook is preferably coupled to the second kinematic linkage by means of a control arrangement. This ensures direct coupling of the movement of the catch hook to the movement of the second roof part, thus making it possible to dispense with a separate drive means and a separate control device for the catch hook. It is particularly preferred that the control arrangement be designed as a multi-bar arrangement. Here, the control arrangement can advantageously be arranged in a position beyond dead center in the opened position of the folding top, thus ensuring that the catch hook is secured against unwanted pivoting and that the first roof part is supported in a stable manner.

The folding top arrangement preferably comprises at least one third roof part mounted immovably on the holding part. Provision is preferably made here for the holding part to have a mounting section, which projects forward beyond the third roof part, and for the first kinematic linkage to be mounted completely in the first mounting section. In this way, which is very particularly advantageous, both the first roof part link and the second roof part link can be arranged in a first mounting region of the holding part, making the involved recessing of the second roof part link, in the third roof part for example, unnecessary. As an alternative or in addition, provision can be made for the holding part to have a second mounting section, which projects rearward beyond the third roof part, and for the second kinematic linkage to be mounted completely in the second mounting section.

The first roof part, the second roof part and the third roof part are expediently deposited with a camber being oriented in the same direction when the folding top is opened. In a first, preferred, embodiment, the first roof part, the second roof part and the third roof part are each designed as rigid shell components and, when the folding top is closed, outward-facing outer surfaces of the shell components can already directly form an outer skin of the folding top. It has to be understood that at least parts of the first roof part, the second roof part and the third roof part can also be covered or spanned with a folding top cloth or that at least some of the group comprising the first roof part, the second roof part and the third roof part can be designed as frame components carrying a folding top cloth.

Independently of the above, a further aspect of the invention relates to a support arrangement for fixing a roof part relative to a holding part of a folding top arrangement, in which the support arrangement comprises a gripping element that can be brought into engagement with the roof part, in which a kinematic control mechanism that guides the gripping element is provided, in which the gripping element can be moved by means of the kinematic control mechanism between a position in engagement with the roof part and a position released from the roof part, and in which a movement of the gripping element can be coupled to a movement of the roof part.

Further advantages and features of the invention will become apparent from the following description of preferred illustrative embodiments of the invention.

The invention is explained in greater detail below with reference to the attached figures by means of two illustrative embodiments of a folding top arrangement according to the invention.

### BRIEF DESCRIPTION OF THE DRAWINGS

FIG. 1 shows a first illustrative embodiment of a folding top arrangement according to the invention with the folding top completely closed.

FIG. 2 shows the folding top arrangement from FIG. 1 in a schematic representation, in which, in particular, links of the folding top arrangement are shown schematically.

FIG. 3 shows the folding top arrangement from FIG. 1 in a partially opened intermediate position.

FIG. 4 shows the folding top arrangement in the intermediate position in accordance with FIG. 3 in a schematic view.

FIG. 5 shows the folding top arrangement from FIG. 1 with the folding top completely opened.

FIG. 6 shows the folding top arrangement in the completely opened position in accordance with FIG. 5 in a schematic view.

FIG. 6a shows an enlargement of the illustration from FIG. 6, with links of a conventional four-bar arrangement for the first roof part additionally being shown.

FIG. 7 shows a second illustrative embodiment of a folding top arrangement according to the invention with the folding top completely closed.

FIG. 8 shows the folding top arrangement from FIG. 7 in a schematic representation.

FIG. 9 shows the folding top arrangement from FIG. 7 in a partially opened intermediate position.

FIG. 10 shows the folding top arrangement in the intermediate position in accordance with FIG. 9 in a schematic view.

FIG. 11 shows the folding top arrangement from FIG. 7 with the folding top completely opened.

FIG. 12 shows the folding top arrangement in the completely opened position in accordance with FIG. 11 in a schematic view.

### DETAILED DESCRIPTION

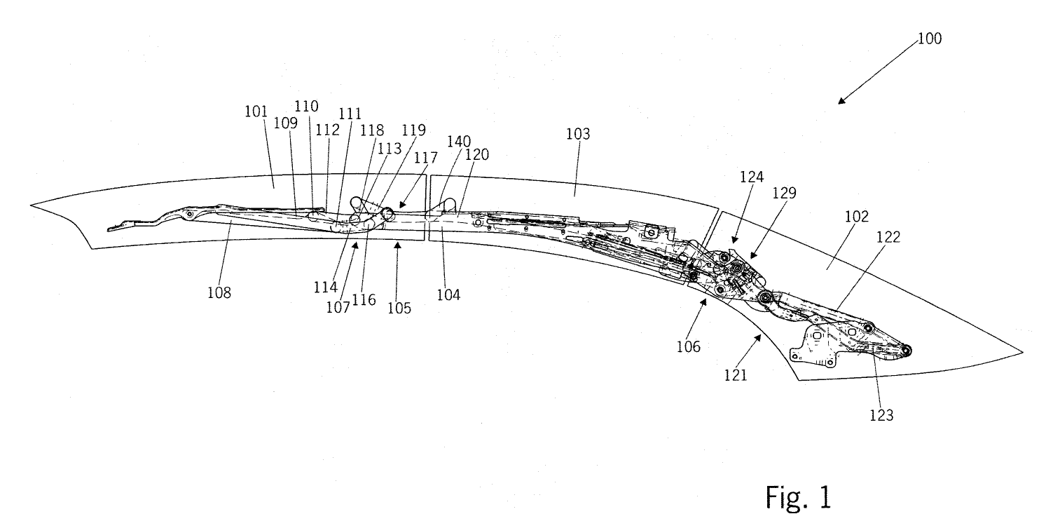

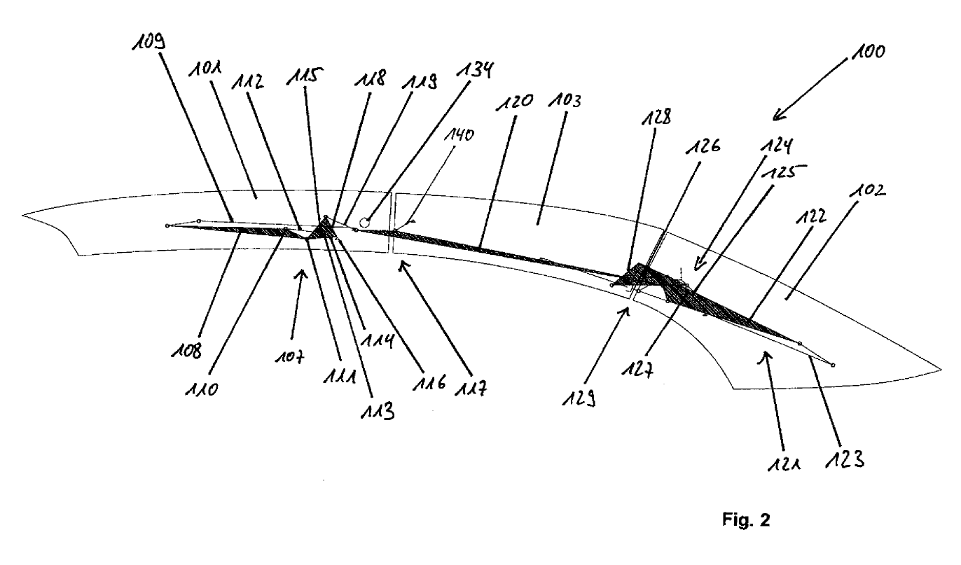

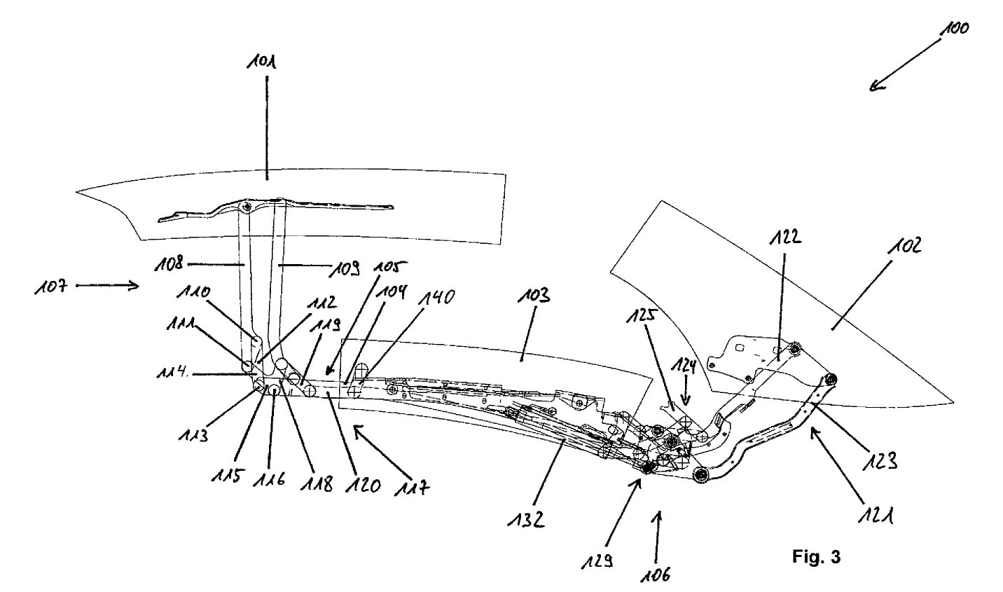

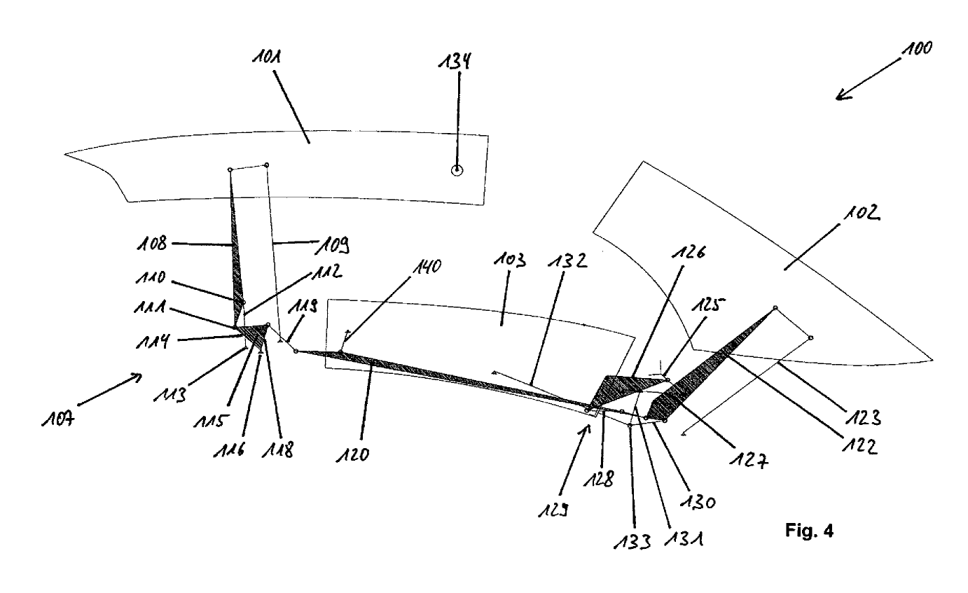

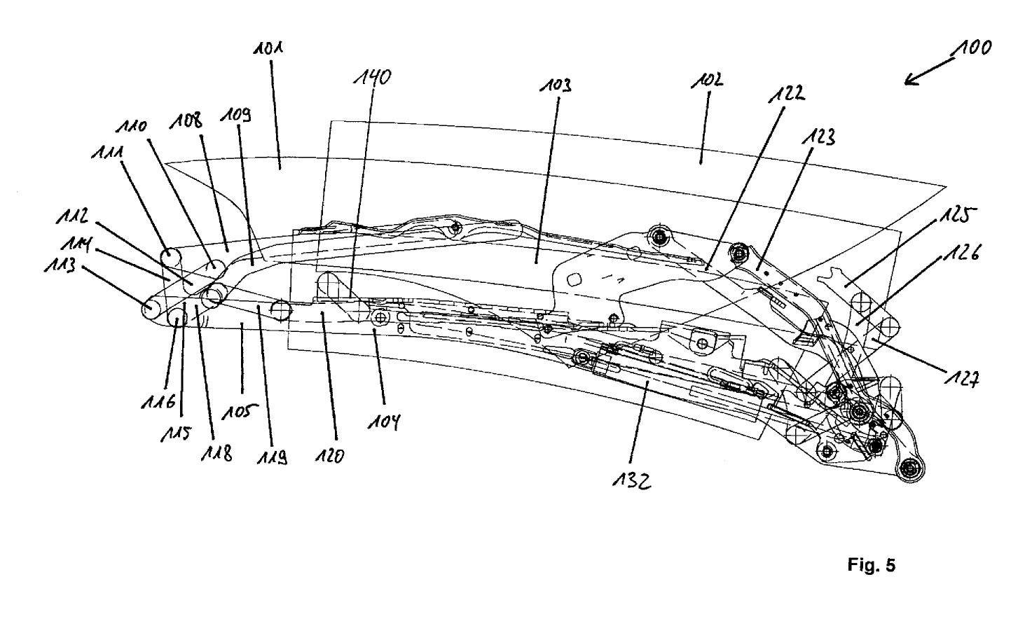

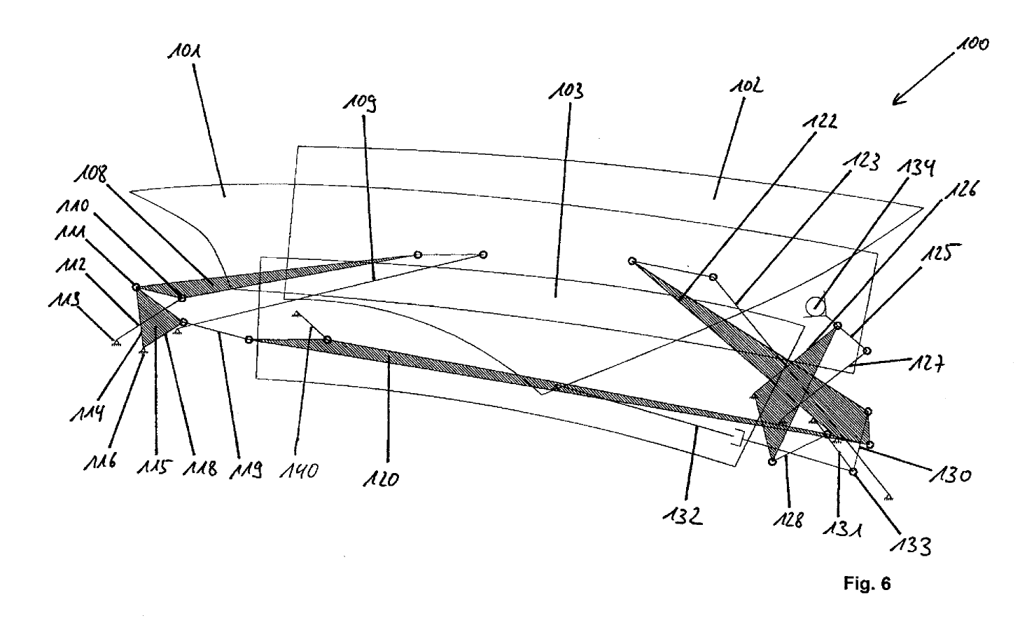

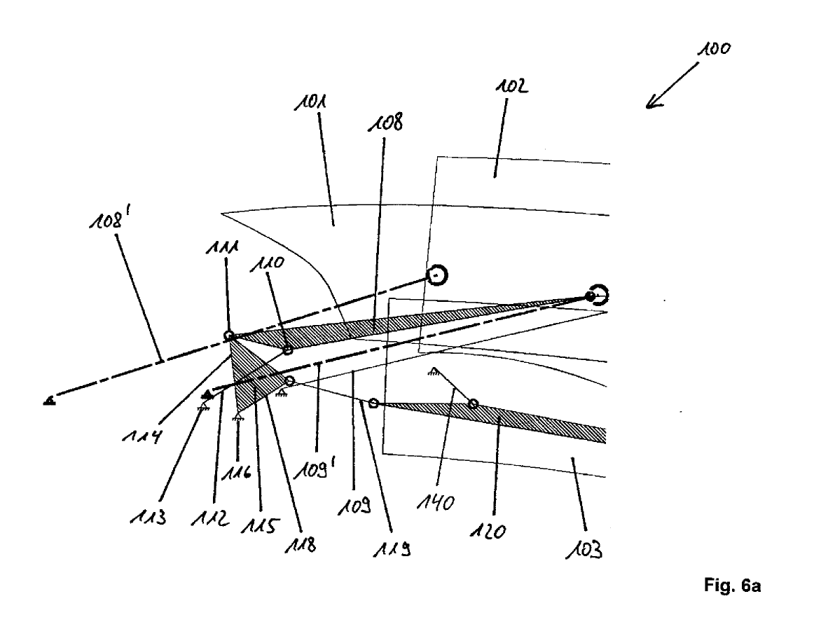

FIG. 1 to FIG. 6 show a first illustrative embodiment of a folding top arrangement 100 according to the invention. The folding top arrangement 100 comprises a first roof part 101, which is at the front in relation to the direction of travel, a second roof part 102, which is at the rear in relation to the direction of travel, and a third, central, roof part 103. FIG. 1, FIG. 3 and FIG. 5 each show the folding top arrangement 100 in a side view, in which the roof parts 101, 102, 103 and a kinematic roof linkage that connects the roof parts 101, 102, 103 to one another can be seen. The kinematic roof linkage is arranged symmetrically on each side of the vehicle, but only links provided on the left hand side of the vehicle in relation to the direction of travel are shown in FIG. 1 to FIG. 6 respectively. In the illustration in accordance with FIG. 2, FIG. 4 and FIG. 6, the folding top arrangement 100 is in each case shown in a folding top position corresponding to the illustration in accordance with FIG. 1, FIG. 3 and FIG. 5, but links of the kinematic roof linkage are represented only schematically. Links which have a total of just two pivot points are represented as a straight line between the pivot points. Links which are connected to other components by more than two pivot points are represented schematically as closed hatched polygons in which each pivot point forms one corner of the polygon. A holding part 104 visible in FIG. 1, FIG. 3 and FIG. 5 is not shown in FIG. 2, FIG. 4 and FIG. 6. Common pivot points of elements that can each be moved relative to the holding part 104 are represented as circles in FIG. 2, FIG. 4 and FIG. 6, while pivot points which connect one element of the kinematic roof linkage to the holding part 104 are represented as triangles. As is readily apparent, for example, from a comparison of FIG. 3 and FIG. 4, the links represented schematically as straight lines in FIG. 4 are frequently designed with a single or multiple offset and curvature. It has to be understood that the links can be curved or offset not only in the illustrated plane of the drawing but also in a direction perpendicular to the plane of the drawing.

As is readily apparent especially in FIG. 3 and FIG. 5, the third roof part 103 is mounted immovably on the holding part 104. In the present case, the holding part 104 is designed as a metal part with multiple offsets extending substantially in the direction of travel. The third roof part 103 extends across the interior of the vehicle in the transverse direction of the vehicle and is mounted on the holding part 104 in the region of the vehicle side face. The holding part 104 has a first mounting section 105, which extends forward beyond the third roof part 103 in the direction of travel, and a second mounting section 106, which extends beyond the third roof part 103 counter to the direction of travel.

The first roof part 101 is mounted movably on the holding part 104 in the region of the first mounting section 105 by means of a first kinematic linkage 107. As can be seen by comparing the illustration in FIG. 1, FIG. 3 and FIG. 5, the first roof part 101 can be pivoted rearward in a direction counter to the direction of travel, starting from the completely closed position of the folding top arrangement 100 illustrated in FIG. 1, into a position above the third roof part 103. The pivoting motion of the first roof part 101 is guided by means of the first kinematic linkage 107. The first kinematic linkage 107 comprises a first roof part link 108, which is at the front in relation to the direction of travel, and a second, rear, roof part link 109. The first roof part link 108 and the second roof part link 109 are each pivoted to the first roof part 101 at adjacent points at a first end remote from the holding part 104. At its second end, the end adjacent to the holding part 104, the first roof part link 108 has a first pivot point 110 and a second pivot point 111. A first auxiliary link 112 with a first end remote from the holding part 104 and a second end adjacent to the holding part 104 is pivoted at its first end to the first roof part link 108 at the first pivot point 110. The first auxiliary link 112 is pivotally attached to the holding part 104 at its second end at a third pivot point 113. A second auxiliary link 114, which in the present case is designed as a first link arm of a knee lever 115, is pivoted to the first roof part link 108 at a first end, the end remote from the holding part 104, at the second pivot point 111. The auxiliary link 114 is furthermore attached pivotably to the holding part 104 at a fourth pivot point 116. The fourth pivot point 116 is arranged in a connection area between the first link arm and a second link arm of the knee lever 115. The holding part 104, the first roof part link 108, the first is auxiliary link 112 and the second auxiliary link 114 together form a first four-bar arrangement, the pivot points of which are formed by the first pivot point 110, the second pivot point 111, the third pivot point 113 and the fourth pivot point 116. Here, the holding part 104 forms a ground link and the first roof part link 108 forms a coupler of the first four-bar arrangement. As is readily apparent especially in FIG. 1 and FIG. 2, the first auxiliary link 112 and a second auxiliary link 114 are arranged in a position in which they are substantially parallel to one another and substantially horizontal in the completely closed position of the folding top. As is furthermore readily apparent in FIG. 3 and FIG. 4, when the first four-bar arrangement is pivoted into the intermediate position the first auxiliary link 112 and the second auxiliary link 114 are pivoted into a position in which they intersect, with the result that the first roof part link 108 forming the coupler of the first four-bar arrangement is moved into a substantially vertical position. Finally, as can be seen in FIG. 5 and FIG. 6, the first auxiliary link 112 and the second auxiliary link 114 are furthermore arranged so as to intersect one another in the completely opened position of the folding top, the first roof part link 108 being arranged in a position in which it extends substantially horizontally rearward. The first roof part link 108 can therefore advantageously be moved through a pivoting angle of almost 180 degrees between the completely closed position of the folding top and the completely opened position of the folding top by means of the first four-bar arrangement. Starting from the closed position of the folding top, there is furthermore a vertically upward and rearward movement of the first pivot point 110 and of the second pivot point 111.

At its end remote from the first roof part 101, the second roof part link 109 is pivotally attached directly to the holding part 104. When the first roof part 101 is pivoted, the second roof part link 109 is guided at all times substantially parallel to the first roof part link 108.

Pivoting of the first kinematic linkage 107 and hence pivoting of the first roof part 101 between the completely closed position of the folding top and the completely opened position of the folding top can be driven by means of a kinematic drive mechanism 117. The kinematic drive mechanism 117 comprises a first drive link 118, a second drive link 119 and a coupler rod 120. In the present case, the first drive link 118 is designed as the second link arm of the knee lever 115 and extends from the fourth pivot point 116 to that end of the second link arm of the knee lever 115 which is remote from the holding part 104. The second drive link 119 is designed as a short straight link and has a first end, which is adjacent to the first drive link 118, and a second end, which is adjacent to the coupler rod 120. At its first end, the second drive link 119 is pivoted to the first drive link 118 and, at its second end, it is pivoted to the coupler rod 120. In the present case, the coupler rod 120 extends substantially in a horizontal direction and substantially parallel to the holding part 104. By movement of the coupler rod 120 in a horizontal direction and toward the rear, counter to the direction of travel, a force is exerted on the first drive link 118 via the second drive link 119, as a result of which a torque is exerted on the knee lever 115. In corresponding fashion, pivoting of the first four-bar arrangement and hence of the first kinematic linkage 107 can be driven by movement of the coupler rod 120 in a horizontal direction.

The second roof part 102 is mounted on the second mounting section 106 of the holding part 104 by means of a second kinematic linkage 121. The second kinematic linkage 121 comprises a third roof part link 122, which is at the front in relation to the direction of travel, and a fourth roof part link 123, which is at the rear in relation to the direction of travel. The third roof part link 122 and the fourth roof part link 123 are each pivotally attached to the second roof part 102 at a first end, which is remote from the holding part 104, and, at their second end, which is adjacent to the holding part 104, they are each pivoted to the second mounting section 106 of the holding part 104. Thus, the holding part 104, the second roof part 102, the third roof part link 122 and the fourth roof part link 123 together form a second four-bar arrangement, by means of which, starting from the completely closed position of the folding top, the second roof part 102 can be pivoted forward and into a position above the third roof part 103. The third roof part link 122 has an extension which projects beyond the point of pivotal attachment to the holding part 104 and to which the coupler rod 120 is pivotally attached. By means of a driven movement of the coupler rod 120 in a horizontal direction, the first roof part 101 and the second roof part 102 can thus be pivoted in a synchronized manner relative to one another.

Arranged in the region of the second mounting section 106 is a support arrangement 124 which, when the folding top is completely opened, engages on the first roof part 101 and holds the latter in the position in which it is laid on top of the third roof part 103 in order to avoid unwanted vibration or movement of the first roof part 101 owing to shocks while the convertible is being driven. The support arrangement 124 comprises a gripping element 125, which is designed as a catch hook, a first support link 126 and a second support link 127. The first support link 126 and the second support link 127 are each pivotally attached to the gripping element 125 at a first end and to the holding part 104 at a second end. Thus, the holding part 104, the gripping element 125, the first support link 126 and the second support link 127 together form a third four-bar arrangement, by means of which the gripping element 125 can be moved relative to the holding part 104. The first support link 126 has an extension which projects beyond the point of pivotal attachment to the holding part 104 and on which a first end of a control link 128 of a control arrangement 129 engages. At a second end remote from the first end the control link 128 is pivoted to the coupler rod 120. The support arrangement 124 can thus be driven directly by the coupler rod 120. In the completely opened position of the folding top, the gripping element 125 engages on a support pin 134 attached to the first roof part 101 and holds the first roof part 101 in the completely opened position against vibration or similar unwanted movement.

In the region of the second kinematic linkage 121, the kinematic drive to mechanism 117 has a third drive link 130 and a fourth drive link 131. At a first end, the third drive link 130 engages in a pivoted manner on the third roof part link 122 and, at a second end, is connected to a first end of the fourth drive link 132 at a drive pivot point 133. A second end of the fourth drive link is mounted in a pivoted manner on the holding part 104. A piston rod of a drive unit 132 designed as a piston-cylinder drive unit is furthermore pivotally attached at the drive pivot point 133, said drive unit being supported on the holding part 104 at an end which is remote from the drive pivot point 133 and which is fixed to the cylinder. Actuation of the drive unit 132 changes the length of the part of the piston rod which projects from the cylinder, enabling pivoting of the third roof part link 122 and hence movement of the coupler rod 120 to be driven via the third drive link 130.

The folding top arrangement functions as follows:

Starting from the completely closed position of the folding top, in which the first roof part 101 is fixed against a cowl panel of the front windshield of the convertible (not shown), and in which the first roof part 101, the second roof part 102 and the third roof part 103 are arranged together, adjoining one another, above the interior of the vehicle and cover the latter completely, actuation of the drive unit 132 can be used to initiate a movement of the coupler rod 120 in a substantially horizontal direction counter to the direction of travel and hence synchronous pivoting of the first roof part 101 rearward and of the second roof part 102 forward until the second roof part 102, the first roof part 101 and the third roof part 103 have been brought together one above the other with a camber being oriented in the same direction in a roof part stack. As is readily apparent especially in FIG. 2, FIG. 4 and FIG. 6, the first roof part link 108 and the second roof part link 109 each pivot through an angular range of almost 180 degrees during the movement of the first roof part 101. During this process, the first, front, roof part link 108 is guided relative to the holding part 104 at its second end, that adjacent to the holding part 104, into a position shifted vertically upward and counter to the direction of travel, enabling the first roof part link 108 to be moved into a substantially horizontal position without colliding with the central roof part 103. As is readily apparent especially in FIG. 6a, the pivotal attachment of the first roof part link 108 by means of the first auxiliary link 112 and of the second auxiliary link 114 makes possible a significant reduction in the extent of the first mounting section 105 beyond the region of the third roof part 103 since a conventional four-bar arrangement of the first roof part on the holding part 104 would necessitate pivotal attachment of the two symbolically indicated conventional roof part links 108′, 109′. The extent of the holding part 104 in the horizontal direction is thus significantly reduced, leading to a significantly smaller deposition space for the roof part stack in the rear area of the convertible.

Driven by the coupler rod 120, a movement of the gripping element 125 into a position of engagement with the support pin 134 of the first roof part 101, in which the first roof part is fixed on the holding part in the region of its rearward end in relation to the direction of travel, takes place synchronously with the movement of the first roof part 101 and the second roof part 102.

The sequence of motion of the first roof part 101, the second roof part 102 and the third roof part 103 as illustrated in FIG. 1 to FIG. 6 shows only the formation of the roof part stack. The holding part 104 is pivotally attached to the vehicle body by means of a main four-bar arrangement (not shown) and can be pivoted from the position in which it is arranged centrally above the interior of the vehicle and which is associated with the closed position of the folding top into a deposition area in the rear of the convertible, and, in comparison with the closed position of the folding top, the orientation of the roof parts 101, 102, 103 remains substantially the same. The formation of the roof part stack can be either fully concluded before the beginning of a deposition movement of the holding part 104 in the rear area or can be at least partially simultaneous with the deposition movement of the holding part 104 in the rear area. As an alternative to the linear drive 132, the movement of the coupler rod can be coupled to a pivoting motion of the main four-bar carrying the holding part 104 in order to drive the pivoting motion of the first roof part 101 and the second roof part 102.

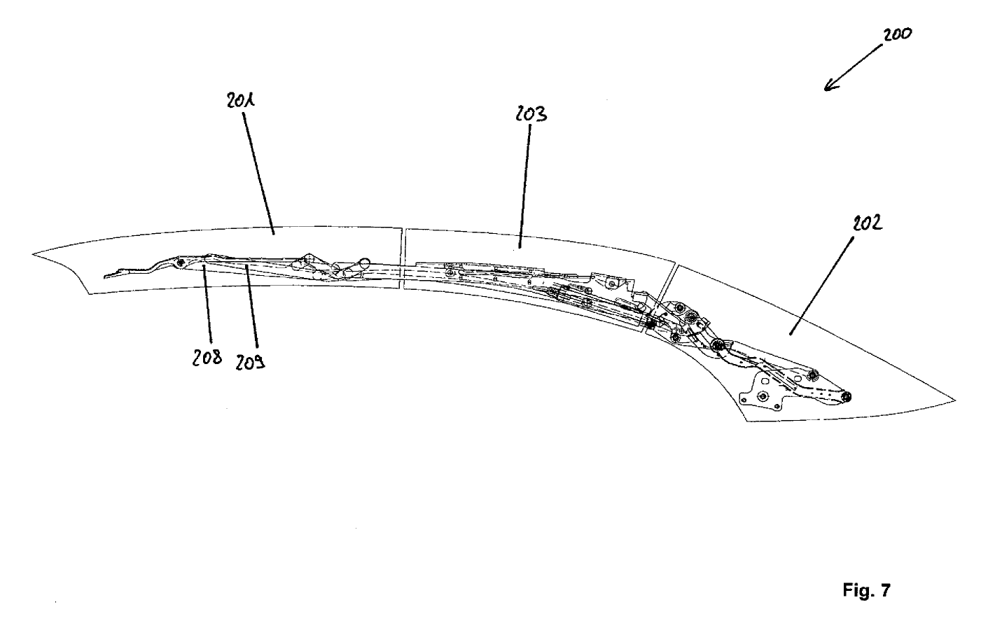

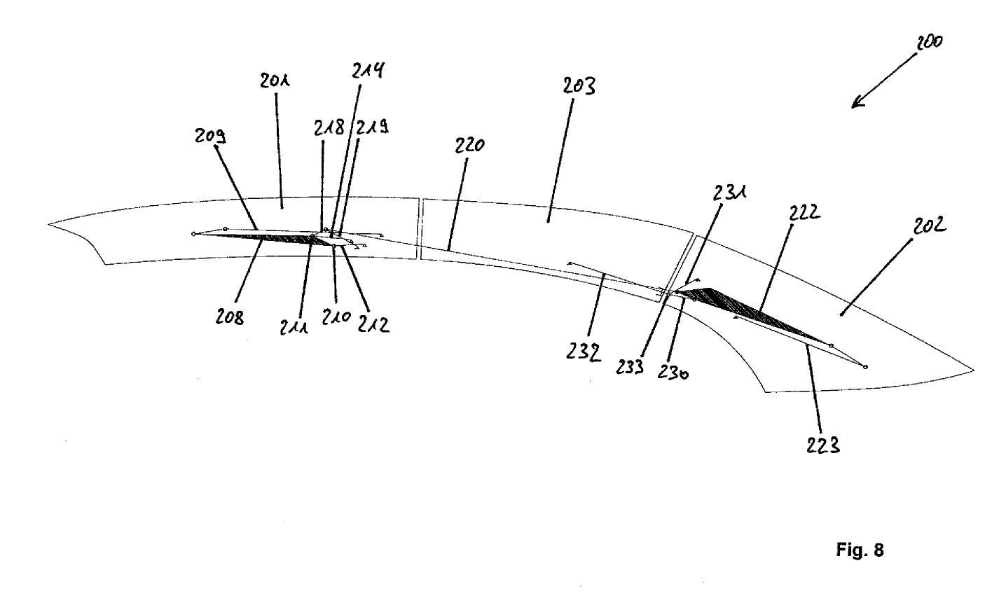

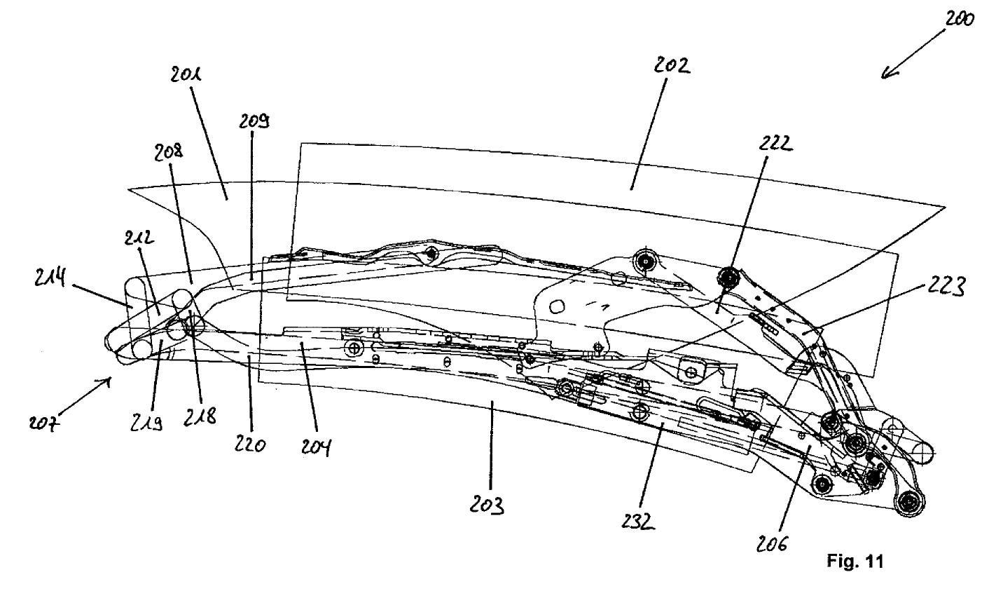

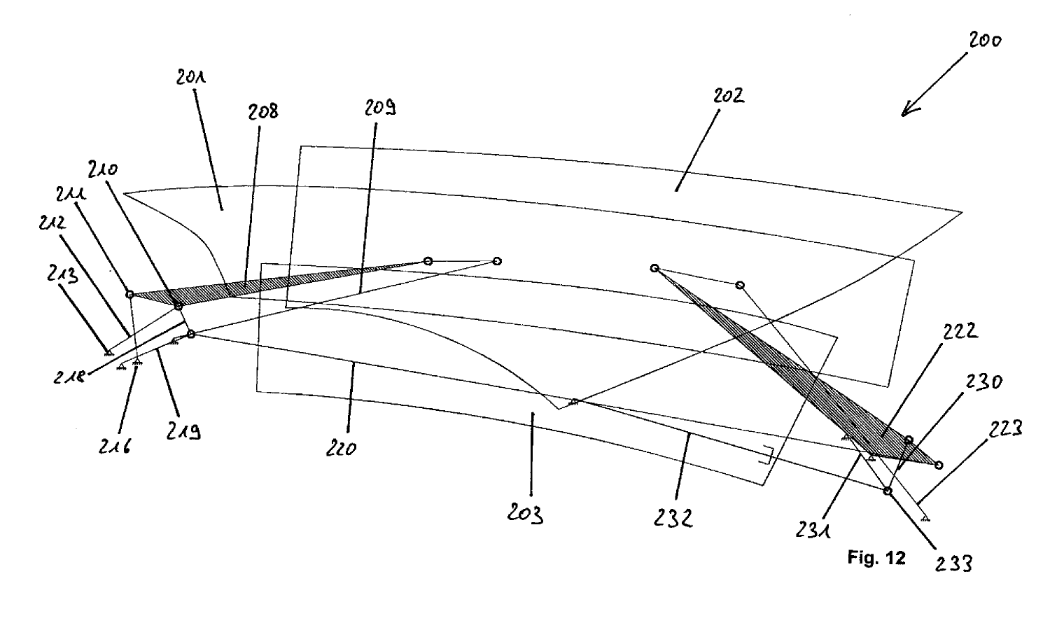

FIG. 7 to FIG. 12 show a second illustrative embodiment of a folding top arrangement 200 according to the invention. Here, components that are identical or have the same function are provided with a reference sign incremented by 100 in comparison with the first illustrative embodiment. In the text which follows, the focus will be primarily on the differences between the second illustrative embodiment and the first illustrative embodiment.

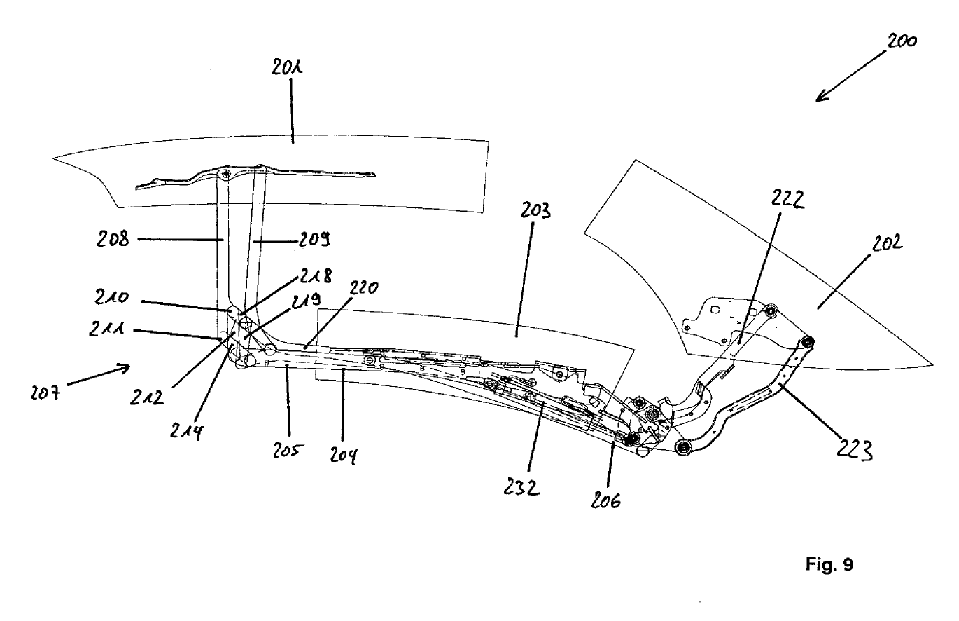

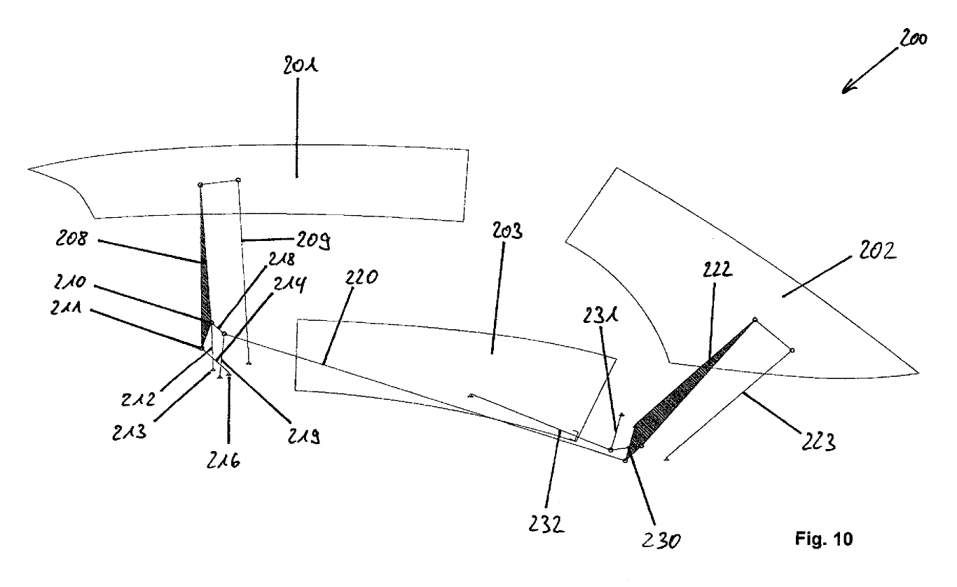

As is readily apparent especially in FIG. 9 and FIG. 10, the kinematic drive mechanism 217 in accordance with the second illustrative embodiment has a first drive link 218 which can be moved relative to the second auxiliary link 212, the first drive link 218 being pivotally attached at a first end to the first pivot point 210 of the first roof part link 208 and being connected at its second end to a second drive link 219, which is, in turn, pivotally attached to the holding part 204. The coupler rod 220 is pivotally attached to the common pivot point of the first drive link 218 and the second drive link 219. Accordingly, the first drive link 218 is not designed as a link arm of a knee lever but as a short link. The first auxiliary link 212 and the second auxiliary link 214 are furthermore arranged in such a way that they intersect one another as the first roof part 201 is pivoted rearward.

The kinematic drive mechanism 217 in accordance with the second illustrative embodiment advantageously has improved introduction of force by the coupler rod 220 into the first kinematic linkage 107 when driving the movement of the first roof part 201 out of the completely opened position into the closed position since the first drive link 218, which transmits a pulling or pushing force of the coupler rod 220 to the first kinematic linkage 209, is guided and supported by the second drive link 219 in contrast to the second drive link 119 of the first illustrative embodiment, with the result that points of pivotal attachment of the first drive link 218 are subjected to lower loads.

Moreover, in the folding top arrangement 200 in accordance with the second illustrative embodiment, no support arrangements corresponding to the support arrangements 124 of the first illustrative embodiment are provided.

In the above description, the invention has been explained by means of two preferred illustrative embodiments, in which the second roof part is arranged in a position above the roof part in the completely opened position of the folding top. It has to be understood that it is likewise possible for the first roof part to be arranged in a position above the second roof part with the folding top completely opened, for which purpose, in particular, the longitudinal extent of the first auxiliary link and of the second auxiliary link is adapted or a four-bar arrangement can also be provided for the second roof part link on the holding part. It likewise has to be understood that a multi-bar arrangement can also be provided for the pivotal attachment of the third roof part link and/or the fourth roof part link of the second roof part, in particular in order to shorten a rearward extent of the second mounting section beyond the third roof part.

In the two illustrative embodiments of a folding top arrangement 100, 200 explained above, the holding part 104, 204 is in each case designed as a continuous metal part which carries the third roof part 103, 203. It has to be understood that the holding part can also be constructed in one piece with the third roof part or that two parts separately attached to the third roof part, which extend forward and rearward respectively beyond the third roof part, form the holding part together with the third roof part.

The roof parts 101, 102, 103, 201, 202, 203 in the illustrative embodiments explained above are each designed as rigid shell components. It has to be understood that some or all of the roof parts can also be designed as rigid shell components at least partially covered with folding top cloth or as folding top linkages carrying a folding top cloth.

1. A folding top arrangement for a convertible, comprising
a first roof part, and
a holding part,
wherein the first roof part is arranged in front of the holding part when the folding top is closed,
wherein the first roof part can be pivoted rearward over the holding part,
wherein the first roof part is mounted on the holding part by means of a drivable first kinematic linkage,
wherein the first kinematic linkage comprises a first, front, roof part link, a second, rear, roof part link, a first auxiliary link and a second auxiliary link,
wherein the holding part, the first roof part link, the first auxiliary link and the second auxiliary link together form a first four-bar arrangement,
wherein the holding part forms a ground link of the first four-bar arrangement, and
wherein the first roof part link forms a coupler of the first four-bar arrangement.

2. The folding top arrangement as claimed in claim 1, wherein the first auxiliary link and the second auxiliary link can be arranged in a position in which they intersect.

3. The folding top arrangement as claimed in claim 1, further comprising a kinematic drive mechanism, which drives the first kinematic linkage, wherein the kinematic drive mechanism comprises a first drive link, a second drive link and a coupler rod.

4. The folding top arrangement as claimed in claim 3, wherein the first drive link is coupled rigidly to one of the first auxiliary link and the second auxiliary link.

5. The folding top arrangement as claimed in claim 3, wherein the first drive link is guided at least predominantly parallel to one of the first auxiliary link and the second auxiliary link as the first roof part is pivoted.

6. The folding top arrangement as claimed in claim 3, wherein one of the first auxiliary link and the second auxiliary link, the first drive link, the second drive link and the holding part together form a four-bar drive arrangement, and wherein the coupler rod is pivotally attached at a pivot point of the four-bar drive arrangement.

7. The folding top arrangement as claimed in claim 1, further comprising a second roof part, the second roof part being mounted on the holding part by means of a drivable second kinematic linkage.

8. The folding top arrangement as claimed in claim 7, wherein the second roof part is arranged behind the holding part when the folding top is closed, and wherein the second roof part can be pivoted forward over the holding part.

9. The folding top arrangement as claimed in claim 7, wherein the second roof part can be pivoted into a position above the first roof part.

10. The folding top arrangement as claimed in claim 7, wherein the first roof part can be pivoted into a position above the second roof part.

11. The folding top arrangement as claimed in claim 7, wherein the second kinematic linkage comprises a third roof part link and a fourth roof part link, the holding part, the third roof part link, the second roof part and the fourth roof part link together forming a second four-bar arrangement.

12. The folding top arrangement as claimed in claim 7, further comprising a kinematic drive mechanism, which drives the first kinematic linkage, wherein the second kinematic linkage is positively coupled to the kinematic drive mechanism.

13. The folding top arrangement as claimed in claim 12, wherein the coupler to rod is pivotally attached to one of the third roof part link and the fourth roof part link.

14. The folding top arrangement as claimed in claim 1, further comprising a support arrangement for fixing the first roof part in the opened position of the folding top.

15. The folding top arrangement as claimed in claim 14, wherein the support arrangement comprises a gripping element that can be moved relative to the holding part.

16. The folding top arrangement as claimed in claim 15, wherein the gripping element is mounted on the holding part by means of a first support link and a second support link, and wherein the holding part, the first support link, the gripping element and the second support link together form a four-bar.

17. The folding top arrangement as claimed in claim 14, further comprising a second roof part, the second roof part being mounted on the holding part by means of a drivable second kinematic linkage, wherein the catch hook is coupled to the second kinematic linkage by means of a control arrangement.

18. The folding top arrangement as claimed in claim 14, further comprising a kinematic drive mechanism, which drives the first kinematic linkage, wherein the kinematic drive mechanism comprises a coupler rod, and wherein the control arrangement is coupled to the coupler rod.

19. The folding top arrangement as claimed in claim 17, wherein the control arrangement is designed as a multi-bar arrangement.

20. The folding top arrangement as claimed in claim 1, further comprising a third roof part mounted immovably on the holding part.

21. The folding top arrangement as claimed in claim 20, wherein the holding part has a first mounting section, which projects forward beyond the third roof part, and wherein the first kinematic linkage is mounted completely on the first mounting section.

22. The folding top arrangement as claimed in claim 20, further comprising a second roof part, the second roof part being mounted on the holding part by means of a drivable second kinematic linkage, wherein the holding part has a second mounting section, which projects rearward beyond the third roof part, and wherein the second kinematic linkage is mounted completely on the second mounting section.

23. The folding top arrangement as claimed in claim 20, further comprising a second roof part, wherein the first roof part, the second roof part and the third roof part each have a camber, and wherein the camber of the first roof part, the second roof part and the third roof part is oriented in the same direction when the folding top is opened.

24. A support arrangement for fixing a roof part relative to a holding part of a folding top arrangement, comprising
a gripping element that can be brought into engagement with the roof part, and
a kinematic control mechanism that guides the gripping element,
wherein the gripping element can be moved by means of the kinematic control mechanism between a position in engagement with the roof part and a position released from the roof part, and
wherein a movement of the gripping element can be coupled to a movement of the roof part.
